(19) United States
(12) Patent Application Publication
(10) Pub. No.: US 2026/0284907 A1
(43) Pub. Date: Sep. 24, 2026

(54) APPARATUS, SYSTEM AND METHOD FOR PROVIDING A HAPTIC RETICLE GRIPPER END EFFECTOR

(71) Applicant: JABIL INC., St. Petersburg, FL (US)

(72) Inventor: Jeroen Bosboom, St. Petersburg, FL (US)

(21) Appl. No.: 19/490,971

(22) PCT Filed: Jun. 11, 2024
(86) PCT No.: PCT/US2024/033414

§ 371 Date: Dec. 8, 2025

Related U.S. Application Data
(60) Provisional application No. 63/521,052, filed on Jun. 14, 2023.

(51) Int. Cl. B25J 15/02; B25J 13/08; B25J 19/02

(52) U.S. Cl. CPC B25J 15/0293; B25J 13/082; B25J 13/088; B25J 19/023; B25J 19/025

(57) ABSTRACT

An apparatus, system and method for a compact reticle gripper end effector. Included in the embodiments are: a housing; two gripper jaws capable of, in combination, gripping the reticle on opposing sides thereof while the reticle is in a compact box, when the two gripper jaws are closed towards each other, the two gripper jaws being located at opposing ends of the housing; an actuator within the housing and capable of opening and closing the two gripper jaws; force feedback sensors for sensing gripping of the two gripper jaws; and a dedicated robotic interface along the housing opposite the two gripper jaws, the dedicated robotic interface capable of interfacing to a 6 axis robotic arm capable of moving the housing.

### CROSS-REFERENCE TO RELATED APPLICATIONS

This application claims priority to U.S. provisional application No. 63/521,052, entitled “Apparatus, System and Method for Providing a Haptic Reticle Gripper End Effector,” filed on Jun. 14, 2023, the contents of which are incorporated herein by reference in its entirety.

### FIELD OF THE INVENTION

The disclosure relates generally to manufacturing, and, more particularly, to an apparatus, system, and method of providing a haptic reticle gripper end effector.

### BACKGROUND

Semiconductor manufacturing requires handling glass “negative” reticles for the purpose of creating nanometer scale patterns upon which semiconductor circuits are constructed, layer by layer. The reticle (also referred to as a reticule, or a graticule) is thus a pattern built into, for example, a photolithographic lens, to provide reference markings. Semiconductor lithography requires handling of such reticles, which are typically formed of glass, for the purpose of creating the nanometer scale patterns upon which semiconductor chip patterns are based.

The reticles are made from a variety of ultra-pure glass and typically have specially applied coatings and carry complex chip designs. The materials and circuit design involved may raise the reticle's cost into the hundreds of thousands of dollars and more.

The safe storage and handling of a reticle often involves a “reticule box” or a “compact box” (CB) shipping container, in which resides one reticle. While the CB is generally safe to handle manually in a clean room when using cleanroom etiquette and methods, opening the CB to remove or replace the reticle is best handled inside a robotic work cell, preferably with a separately controlled cleanroom environment, inside the cleanroom itself. Automated handling of the reticle keeps contamination of the reticle at an absolute minimum-a necessity for efficient semiconductor fabrication.

However, the design of the industry standard CB shipping and storage container was not made in contemplation of automation as a primary consideration in reticle handling, and consequently very few features suitable to enable automation are present in relation to the CB or the reticle.

The preferred robot for such an application is a six-axis cleanroom robot. While these robots are remarkably versatile, it is also easy to impinge upon the robots limited inner work envelope by using a typical bulky end effector to handle reticles.

Like a human hand and wrist, mounting a powerful and compact gripper onto a six-axis robot is an advantageous design. This helps prevent the robot from colliding with itself while working in the smallest possible work zone.

### SUMMARY OF THE DISCLOSURE

The embodiments provide an apparatus, system and method for a compact reticle gripper end effector. Included in the embodiments are: a housing; two gripper jaws capable of, in combination, gripping the reticle on opposing sides thereof while the reticle is in a compact box, when the two gripper jaws are closed towards each other, the two gripper jaws being located at opposing ends of the housing; an actuator within the housing and capable of opening and closing the two gripper jaws; force feedback sensors for sensing gripping of the two gripper jaws; and a dedicated robotic interface along the housing opposite the two gripper jaws, the dedicated robotic interface capable of interfacing to a 6 axis robotic arm capable of moving the housing.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

FIG. 1 illustrates aspects of an exemplary embodiment of the present invention;

FIG. 2 illustrates aspects of an exemplary embodiment of the present invention;

FIG. 3 illustrates aspects of the embodiments;

FIG. 4 illustrates aspects of the embodiments;

FIG. 5 illustrates aspects of the embodiments;

FIGS. 6A and 6B illustrate aspects of the embodiments;

FIGS. 7A, 7B, 7C, and 7D illustrate aspects of the embodiments;

FIG. 8 illustrates aspects of the embodiments;

FIGS. 9A and 9B illustrate aspects of the embodiments;

FIG. 10 illustrates aspects of the embodiments;

FIGS. 11A and 11B illustrate aspects of the embodiments;

FIG. 12 illustrates aspects of the embodiments;

FIG. 13 illustrates aspects of the embodiments;

FIGS. 14A and 14B illustrate aspects of the embodiments;

FIG. 15 illustrates aspects of the embodiments;

FIG. 16 illustrates aspects of the embodiments;

FIG. 17 illustrates aspects of the embodiments;

FIG. 18 illustrates aspects of the embodiments;

FIG. 19 illustrates aspects of the embodiments;

FIG. 20 illustrates aspects of the embodiments; and

FIGS. 21A and 21B illustrate aspects of the embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

In light of the discussion above, a crucial consideration in the handling of reticles is that the gripper should safely handle the reticle. This handling may be aided by mapping the reticle and the pellicle using integral fiber optics. The end effector should also be capable of retaining a firm hold of the reticle in case the emergency stop is activated, or if the power is unexpectedly cut off.

Another important consideration is the overall cleanliness of the gripper itself. It must not introduce contaminates onto the reticles while gripping and moving them in the work cell. The end effector/gripper should also be as light as possible, since small six-axis robots have a modest outer joint payload and the reticles are relatively heavy.

The disclosed compact reticle gripper is capable of safely handling reticles while taking up a minimum of work envelope. It advantageously uses the shortest possible length inside the work cell. This allows the robot to articulate more freely in the spherical envelope within a smaller work cell envelope. This results in a smaller work cell since less space is allocated for the purpose of robot-end effector clearance inside the work cell. Since semiconductor fab floor space cost is at a premium, building compact robot cells is highly advantageous.

The disclosed very short end effector has a high degree of cleanliness, and includes failsafe features that retain the work in process if emergency stops are activated. Reticles are typically 6×6×0.25 inches thick, but due to the interaction with other tools only a small portion of the reticle can be gripped in the disclosed gripper jaws. For example, typically only 0.50-inch length may be clamped between the jaws, leaving the reticle highly cantilevered.

The disclosed compact gripper end effector detects if a reticle is present in a particular position before picking it to avoid mishandling. Jaw travel sensors may detect open or close, and may be used to let the robot continue to the next point in the work zone.

Also disclosed is a more precise sensing method to assess a slipped reticle or a gripper failure. The robot position can be subjected to occasional discrepancies, such as when an unexpected state happens. In this case, the operator may be reluctant to abort the sequence and without diagnosing the root cause, and may instead choose to proceed into other tooling, thereby damaging the reticle. When this occurs, the disclosed embodiments alert the work cell that the gripper is too far off its next step, which acts as a failsafe and forces the sequence to be cancelled.

The end effector may experience a sudden stop or shock, or may brush other tooling with enough inertia to damage it, for example. In such cases, it is preferable to limit damage to the gripper end effector or to the reticle. As such, the disclosed embodiment provide a special coupling for the gripper jaws to the robotic arm.

Reticles often have a mask/pellicle attached to the bottom surface thereof, and these have different geometries. Often the pellicle is directional, and it must be determined that the reticle assembly has the proper positioning before being sent to the next step. To accomplish this, the disclosed compact gripper end effector has on board fiber optic scanners that interrogate the reticle assembly and only proceed if the orientation is correct.

The disclosed compact reticle gripper end effector may access a reticle in a compact box; a blank box; a single pod; an acclimation station; and other reticle cassettes. The modular jaws may be modularly replaced with dedicated versions for clamping among other items, such as optical lenses, square and round layer substrates, life science items such as vials and vial racks, virtual reality headset parts and assemblies, and so on.

The embodiments provide additional error detection and checking to prevent dropping or damaging of the reticle and pellicle. If a feedback sensor is out of range or reports an error during a run, a stop may be effectuated immediately to limit product or tooling loss. The cost of a single reticle can exceed the work cell cost of the disclosed embodiments, and so the cost of additional sensors and capability quickly pays for itself.

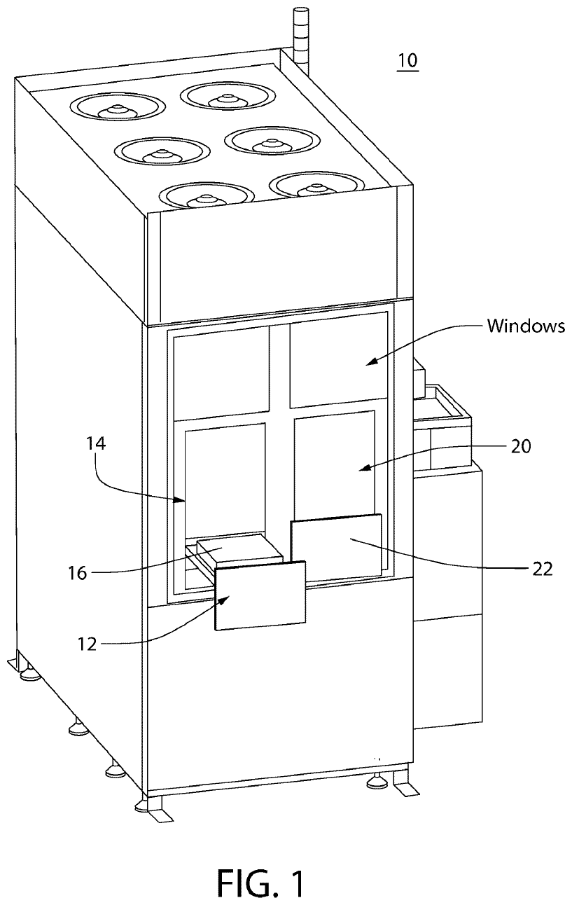

FIG. 1 illustrates a compact box work cell 10. At the lower left of the work cell is a drawer 12 and a port 14 suitable to have a compact box 16 installed therein. As discussed, the drawer 12 may be manually or automatically opened, and the compact box 16 is set upon locating guides in the drawer base. Thus, in order to access the compact box 16 shown within the drawer 12, the port/port shutter 14 is lifted upward to allow for clearance of the compact box 16, and the drawer 12 is pulled outward.

In the illustration, an additional shutter door port 20 and drawer 22 are shown at the right side of the work cell. Moreover, it should be noted that the CB drawer 14 in the illustration is in the open position, with the compact box 16 already placed atop the CB location guides referenced throughout.

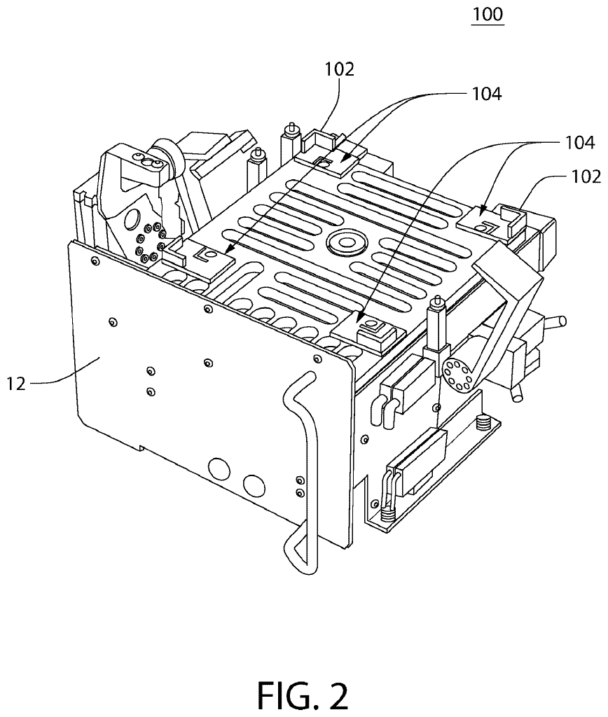

FIG. 2 illustrates the location guides 102, which may have associated therewith one or more vacuum cups 104 to aid in CB retention, on a flowthrough deck 106 of a compact box opener within drawer 12. In the illustration, the plurality of corner locator guides 102 are physically mounted upon, or may be integral with, the topmost surface of the deck 106. The flowthrough deck 106 may provide, for example, targeted airflow and/or vacuum flow therethrough to decrease particulate or other contaminants from being in the presence of the reticle during opening of the compact box.

FIG. 2 is a more particular illustration of a work cell drawer 12 of FIG. 1, with the disclosed compact box opener 100 resident within the drawer 12, which CB opener is capable of receiving a compact box and guiding it into position for opening, while gripping with the vacuum cups 104. In the illustration, the vacuum cups 104 may be located at the base of the guide locators 102 at a small distance from the positional guides 102.

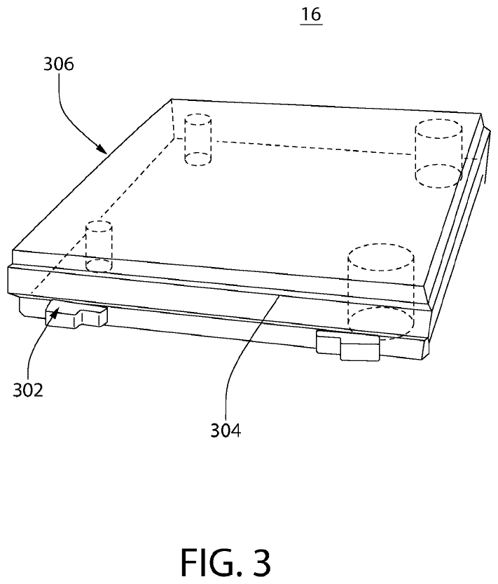

FIG. 3 illustrates a compact box 16. The compact box 16 includes a lower portion/base 302 which has a rim 304 that mates with an upper portion/lid 306. Within the compact box 16, below the lid and resting on corner guides on the base, is a single reticle (not shown).

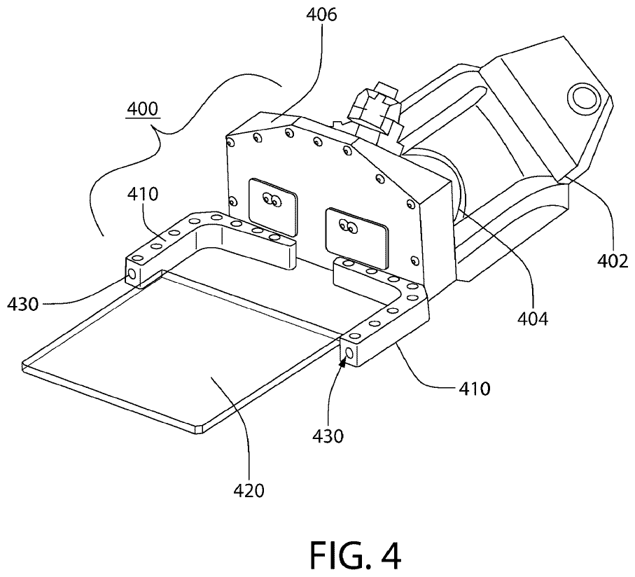

FIG. 4 illustrates a compact reticle gripper 400 mounted on a robotic arm 402 according to the embodiments. Shown in the figure is the mounting body 404 for the reticle gripper, the housing 406 which includes the gripper actuation, and the gripper jaws 410.

The gripper jaws 410 shown are suitable to grip a reticle 420 from within the reticle box 16 discussed above. The gripper actuator within the housing closes the jaws only to the extent and only at the angle necessary to grip and lift the reticle 420 from the box 16, or to place the reticle into the box. The jaw design may be modular, in that the job may be exchanged for other jobs suitable for other tasks. As such, the core gripper body 400, including the jaws 410 and housing 406, may be modular and replaceable on the robot arm 402 for various purposes.

In the embodiment shown, at one or more locations along the jaws, such as the distal most tip of the jaws from the actuation housing, maybe included mapping optical fibers 430. These mapping fibers may map the reticle cassette 16, as well as the reticle 420 itself, to allow for automated adjustments in the maneuvering of the jaws by the robotic arm and or buy the actuators within the housing, in order to best grip the reticle cassette or the reticle itself.

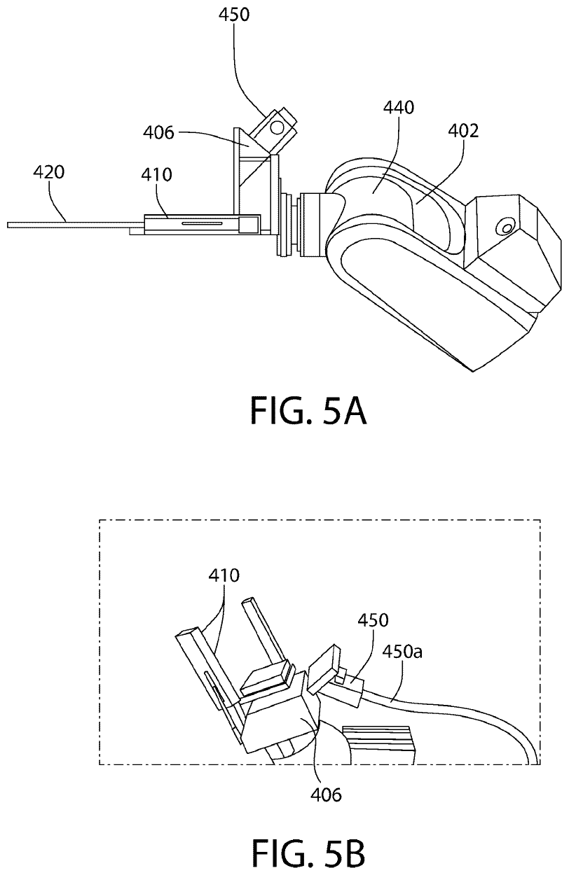

FIG. 5 provides an additional illustration of the compact reticle gripper. As illustrated, the design includes a low overhead, which maximizes the robots working envelope, while minimizing the work cell footprint. This is achieved, in part, by the slim body profile of the actuator and actuator housing 406, and the thin jaw profile of the gripper jaws 410.

As is also shown, the robotic arm 402 includes an acute angle rotation capability 440, which allows for significant angular adjustment of the actuator housing 406 and gripper jaws 410. Also included is a harness connector 450 suitable to provide the means necessary for the actuators within the actuator housing 406. In preferred embodiments, the harness 450a attached to the harness connector 450 is flexible, and includes tight seal fittings that remain in position as the robotic arm 402 rotates and maneuvers the housing and gripper jaws 410 in order to reach into and out of a reticle box 16.

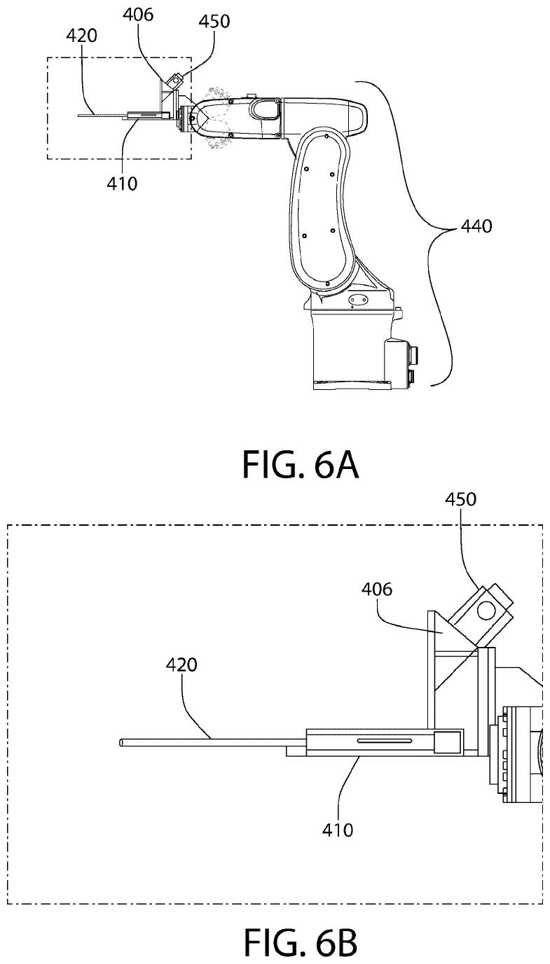

FIGS. 6A and 6B illustrate a 6-axis robot 440 having mounted at the end thereof the disclosed compact reticle gripper. The reticle gripper illustrated is gripping a 6-in reticle, shown by way of example. Also shown in the figures, in addition to the reticle protruding from the minimized profile jaws, is the angular movement capability that the robot arm can impart to the actuator housing. Of note, the six axis capability provides significant increase in the robots working envelope, while minimizing the size of the work zone for the robot and grippers.

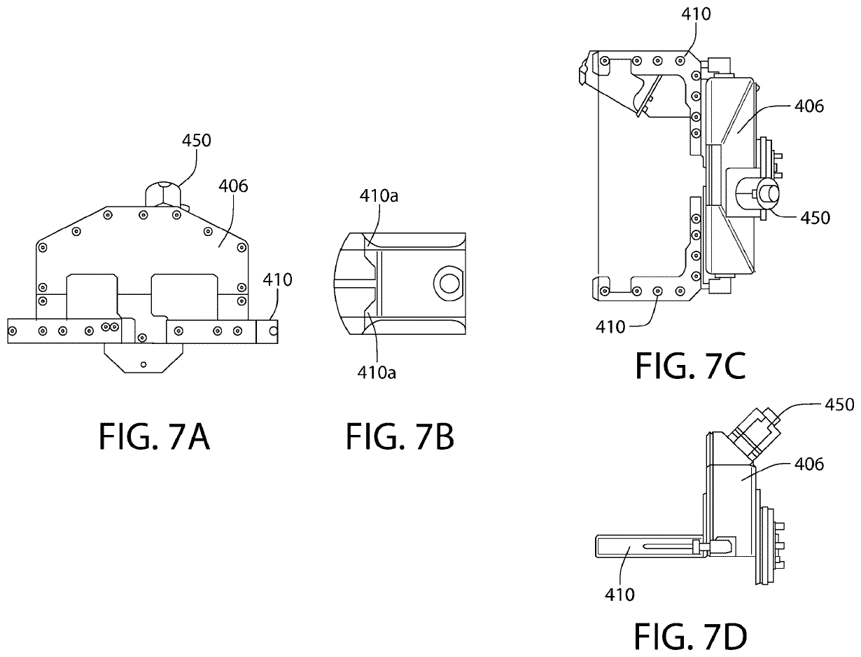

FIGS. 7A, 7B, 7C, and 7D, illustrate front, top, top, and side views of the compact reticle gripper, respectively. In the illustration, the grippers may have a high but very sensitive clamping force, and, for example, a 25 mm stroke. The grippers in combination with the actuator and housing may be of lightweight, such as 2.2 kg.

The grippers may be scavenged for cleanroom level cleanliness, as may be the actuator and actuator housing. The grippers 410 may be, for example, spring loaded, and may include beveled jaw edges 410a suitable to aid in centering a gripped reticle/pellicle, and to minimize contact during gripping.

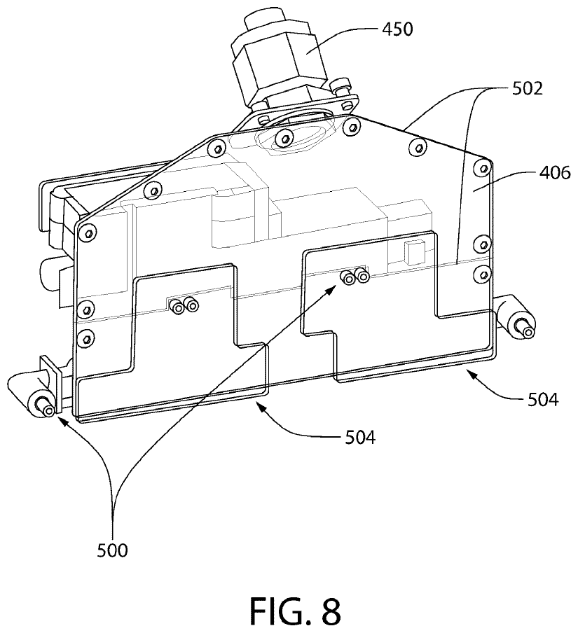

FIG. 8 illustrates various features of the compact reticle gripper housing 406 adjacent to the jaws 410. For example, the connector 450 for the inputs to the housing 406 is shown atop the actuator housing 406, and open and close position sensors 500 for the jaws are provided through or on the faceplate of the actuator housing.

Also Illustrated are removable faceplates 502 in various positions, which may preferably allow access to the interior of the actuator housing without removal of the jaw or jaw assemblies, or of the jaw support plates. These jaw support plates 504 may unify the dual gripper slider blocks, as shown.

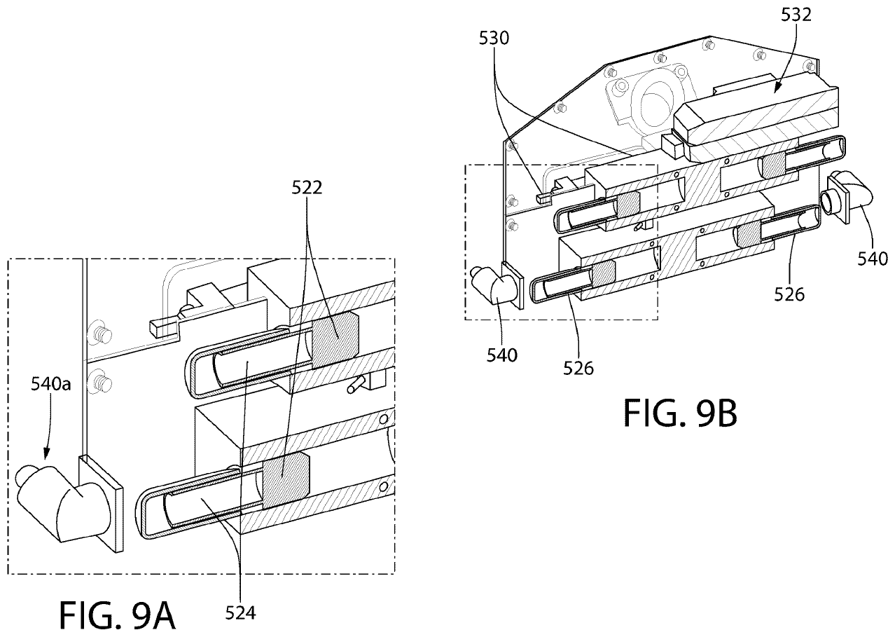

FIGS. 9A and 9B illustrate a gripper cutaway view of the jaw actuators 520 in the actuator housing 406. As shown, gripper pistons 522 may drive gripper actuation, and vented springs 524, such as pressure vented springs, may be housed within spring covers 526 to reduce friction, and be kept aligned by the spring covers. These covered springs maximize power transfer in the embodiments.

As shown, dual crossed rollers 530 may have high moment loading capability using a preloaded spring and piston design, as shown. As such, the grippers may remain closed in the event of an emergency power loss.

Also as shown, the fiber optics may be sealed within fiber optic conduits 540, such as rubber boots 540. Further included maybe fiber optic amplifiers 532, such as within or on the actuator housing.

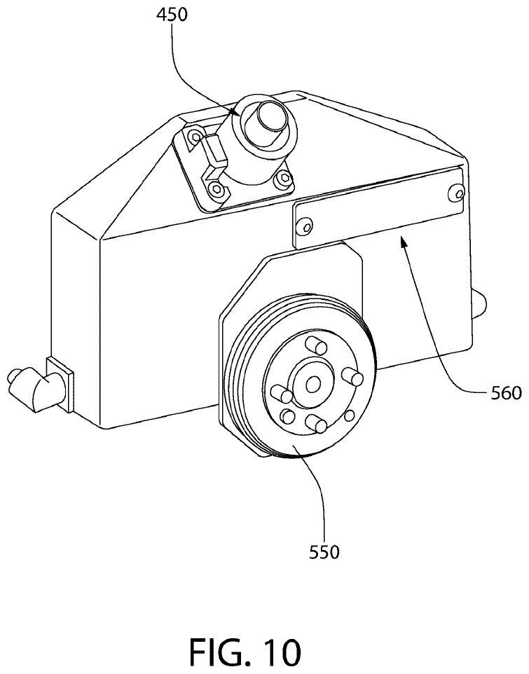

FIG. 10 illustrates the back portion of the actuator housing which provides connectivity to the robot arm. Shown is the seal tight harness inlet 450 at the top most portion of the back plate. The robot adapter 550 in the lower center of the back plate provides a flange for interfacing to the angularly adjustable robot arm. As shown, the flange may provide an emergency breakaway clamp, such as a band clamp. Also illustrated is a fiber optic amplifier viewport 560 which gives access for adjustment as needed to the fiber optics.

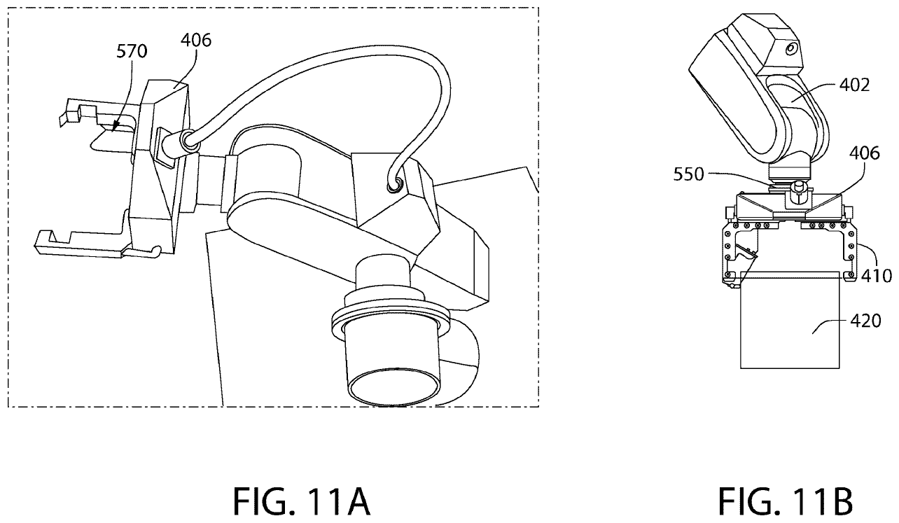

FIGS. 11A and 11B illustrate an actuated compact reticle gripper. In the illustration shown, the scanner 570 detects an improperly clocked reticle 420/pellicle mask. This indicates that the reticle is not in proper position for grasping, and thus the actuation of the jaws 410 will be aborted.

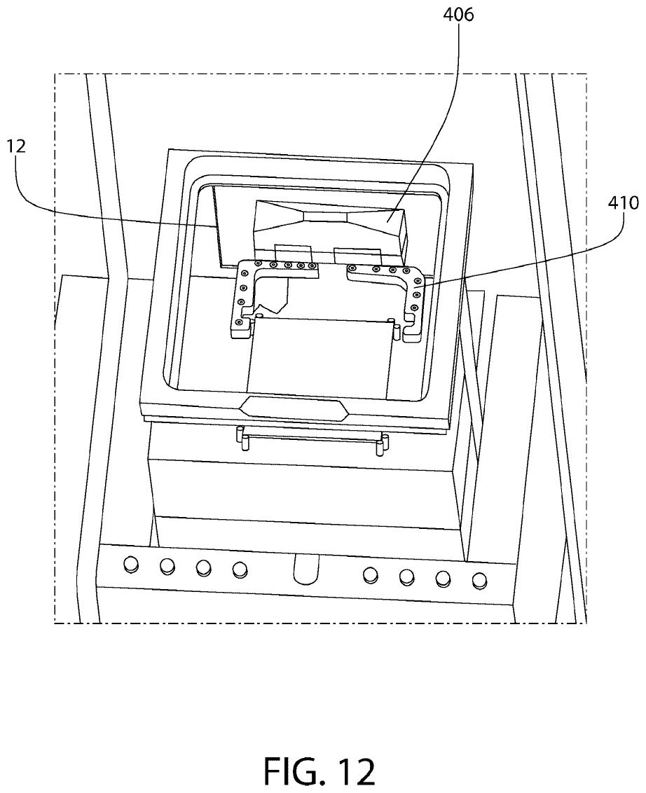

FIG. 12 illustrates a load port pick by the compact reticle gripper. In the illustrations, the gripper reaches through an open load port 12 to grasp the reticle, which is positioned on, for example, kinematic support posts within a compact box. The compact box may be opened by any methodology known to the skilled artisan, such as a standard mechanical interface opener.

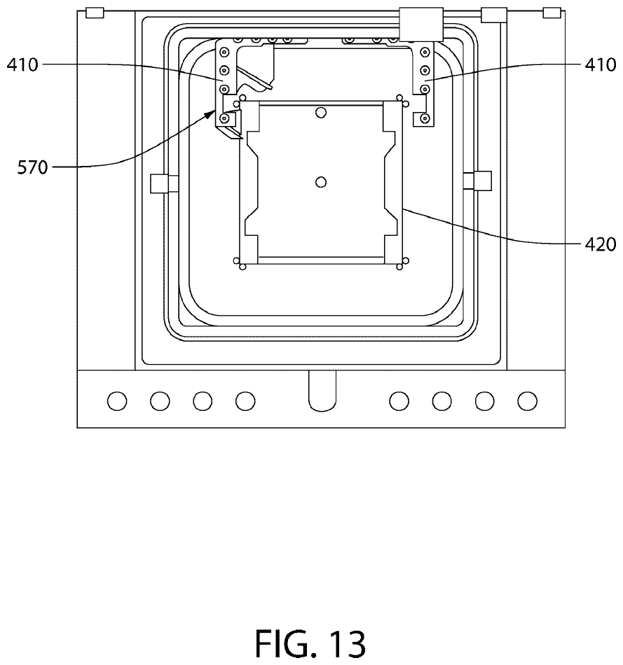

FIG. 13 illustrates a top view of the compact reticle gripper reaching through the open load port 12. In the illustration, the compact reticle gripper optical scanner 570 scans the pellicle mounted below the reticle. The robot and jaw position is then checked by checking the sensor 570 state to confirm that the reticle 420 is clocked properly and that the expected pellicle indication is present.

The scanners enable quick detection of a large variety of reticles and pellicles. This allows seamless handling of a variety of reticles with little to no testing/robotic training.

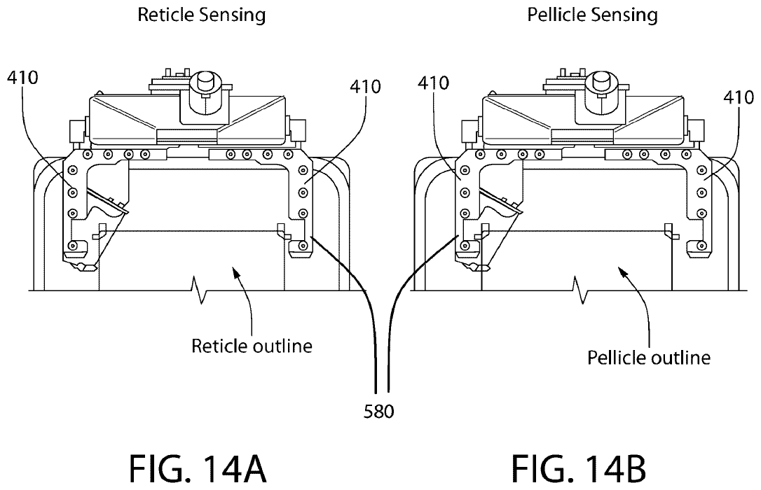

FIGS. 14A and 14B illustrate the sensing of either (or both) a reticle or a pellicle. FIG. 14A shows the outline of the reticle. The sensing beam may traverse through the reticle as it sweeps up vertically.

In FIG. 14B, the pellicle outline is shown. The sensing beam may traverse through the pellicle as it sweeps up vertically.

In each such case, jaw cutouts 580 may provide clearance to scan the sensing beam, and to grip the reticle. The gripper is shown in the open position in FIG. 14.

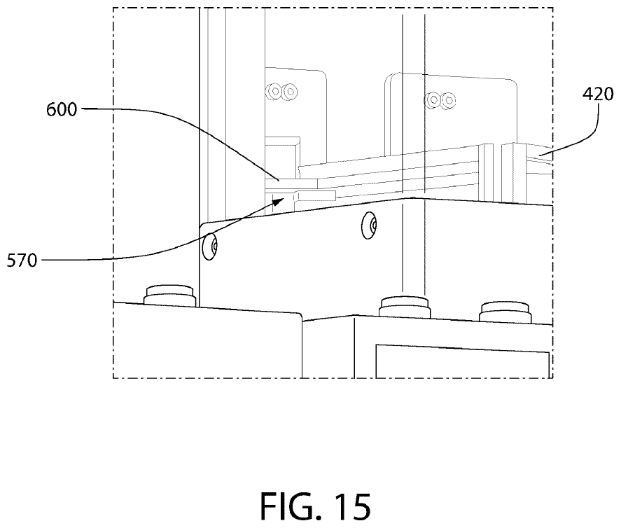

FIG. 15 illustrates the compact reticle gripper actively scanning by scanner 570. In the illustration, a pellicle scanner 600 is also in action. Note the optimized position below the center line of the jaws.

Shown are the reticle 420 and reticle outline, and the scanner beam 570. The beam is scanning for proper positioning of the pellicle, and consequently also of the reticle.

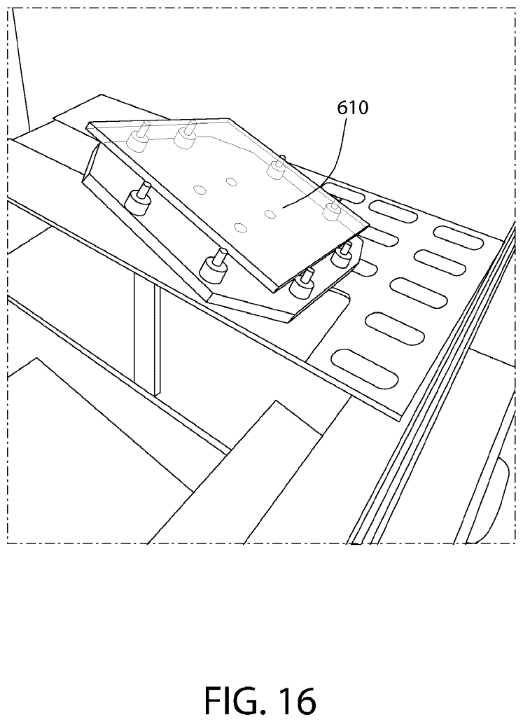

FIG. 16 illustrates an acclimation station 610. The acclimation station resets the reticle offset with respect to the jaws of the reticle gripper. This offset is important when the reticle is dropped off or picked, and is based on the justification of the reticle on the pins of the compact box.

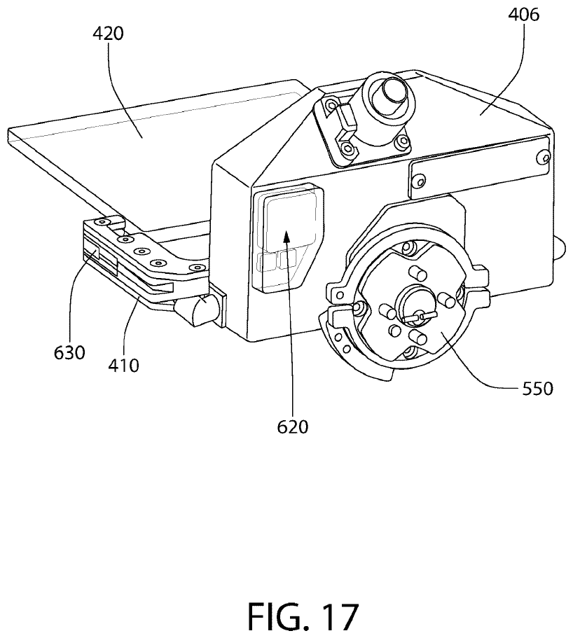

FIG. 17 illustrates an additional embodiment of the reticle gripper, in which a spatial inertial sensor 620 is included. The spatial inertial sensor checks and reports on positioning, and stops path deviations to prevent collisions.

The spatial inertial sensor may detect robot path deviation or accidental collision or strikes. A miniature 3 axis inertia sensor may detect the robot's path and emergency stops in case the robot executes incorrectly, thus stopping the robot motion before it damages valuable parts. The sensor can also record and log if a collision occurs.

Also evident in FIG. 17 is the interface 550 to the robotic arm. This interface 550 may be a breakaway coupling. The breakaway coupling may be a spring loaded circumference clamp, calibrated specifically for this application. The spring loading allows for retention of the end effector even upon separation. Also included may be a breakaway switch, i.e., an electric trip sensor to detect full or momentary detachment.

More particularly, to locate the end effector on the robotic arm, it may be mounted on a robotic coupling consisting of two flanges. This allows repeatable assembly positioning and disassembly of the end effector. Included may be a flange with overload capability and a feedback loop. The drawback to these features may be increases in size or stack height, weight, and extra cost.

The coupling retention limits may be enough to hold the end effector during normal operation, but light enough to detach the end effector partially or fully in the event of a collision. The breakaway coupling may thus be held together by a spring link, which can be mounted to the robot and then to the end effector without separating.

Further, the breakaway coupling halves may be surrounded by a spring-loaded band clamp that adds sufficient retention for normal operation and activation upon a collision. The link spring retains the coupling halves in the event of non-returnable deflection in the halves; that is, the ramp faces are decoupled from the band clamp ramps. A convenient over-center latch on the band clamp makes re-attachment simple.

While the inertia sensor 620 discussed herein may emergency stop the robot, the breakaway coupling 550 may provide flexibility between hard tooling to limit damages as the system powers down in an emergency stop. Even with these additional features, an original stack height of 0.51 inches is maintained, and weight is not appreciably increased.

Also shown in FIG. 17 is the force feedback 630 provided by the smart jaws. In the illustration, the jaws include strain gauges, such as dual axis strain gauges, to measure jaw deflection, thereby measuring gripper payload. The strain gauges detect if the expected gripper pressure is present prior to the robot continuing. They can thus detect if the load being handled is within the weight tolerance expected.

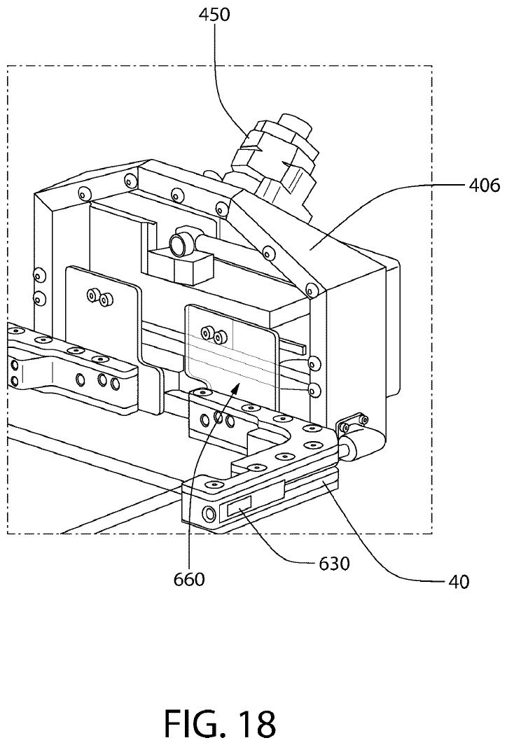

FIG. 18 illustrates another exemplary jaw side view of the actuator housing 406. In the illustration, a gripper travel sensor 660 detects out of range loads relative to grip positions. In an embodiment such as that of FIG. 18, two positions sensors may be eliminated, as may be open close sensors.

More specifically, by incorporating a miniature linear travel sensor 660 in the gripper, gripping loads can be checked at their expected positions to verify that they are in a normal range. For instance, a cross combed reticle that is outside the combing range of the jaw profile will keep the jaw open wider but will still give the same grip force feedback. By discerning the jaw travel versus the load input from the jaw force sensing, an error may be detected, the robot paused, and an accident prevented.

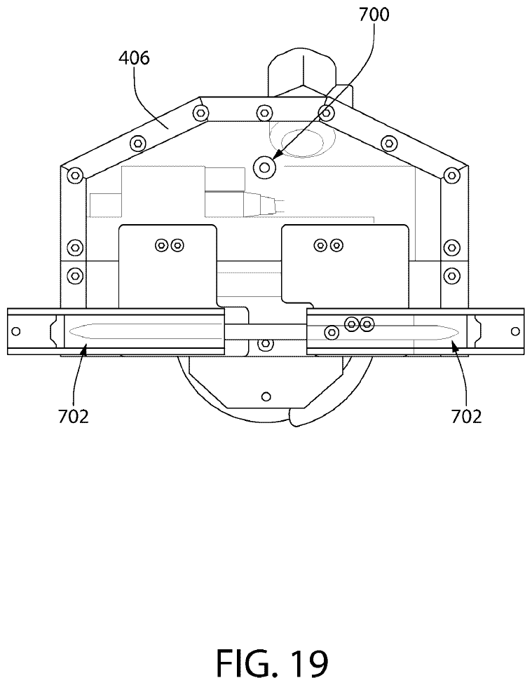

FIG. 19 illustrates a built-in camera 702, such as a point-of-view camera along the jaws, in an exemplary embodiment. This camera may provide a direct line of sight for alignment-checking the gripping jaws. Additionally, a central camera 700 provides a robotic end effector view of the run, and can save a recording before and during detected errors.

Further, position teaching of robot points is typically a manual line of sight process. The operator tries to visually detect if the end effector gripper is in range of a pick or place location. This is often very difficult due to parallax errors and tightly integrated robot cells that make it difficult to visually confirm that a point looks correct. By incorporating miniature cameras in key positions, the task of teaching positions is made easier.

Yet further, the jaw cameras 702 may correspond to the edge of the reticle when the jaws are open. By having a miniature camera in each jaw positioned at the line of sight of the reticle corners, the operator can confirm by way of a display monitor, or machine learning can automatically confirm after training, that the end effector is centered vertically and horizontally in respect to the reticle. By way of example, replaceable target reticles can be mounted between the camera and reticle to gauge where y and z position when teaching a point.

Streaming video can also be captured by a centralized camera 700. The camera may capture the gripper action from a point of view perspective. It can be better judged if pick points are off in X, Y or Z by how the reticle reacts as it is gripped. By streaming the video, accidents can be seen from the robot end effector perspective to find the root cause.

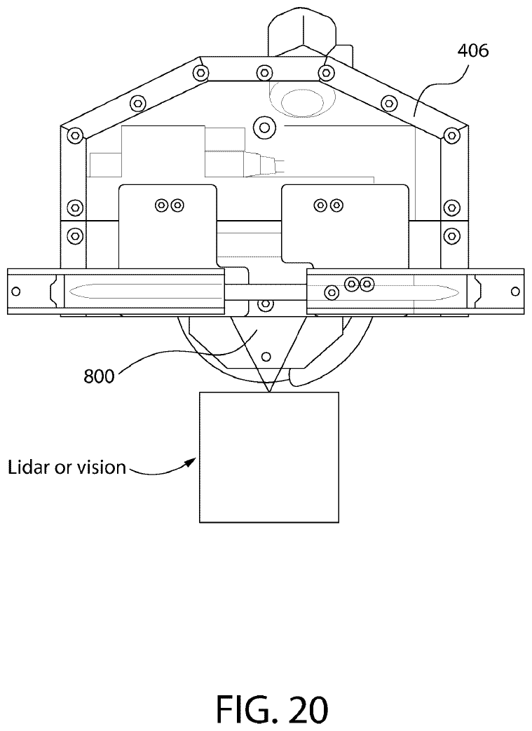

FIG. 20 is a bottom view of the actuator housing 406. Illustrated is Lidar pellicle scanning 800. This scanning facilitates the pellicle orientation check when beam scanning is not feasible. The use of a fixed Lidar sensor (or sensors) may be incorporated in the work cell in the range of the robot. The Lidar may be mounted above or below the robot's horizontal plane. A pattern recognition sensor (low cost vision) 800 can also be used to check pellicle orientation.

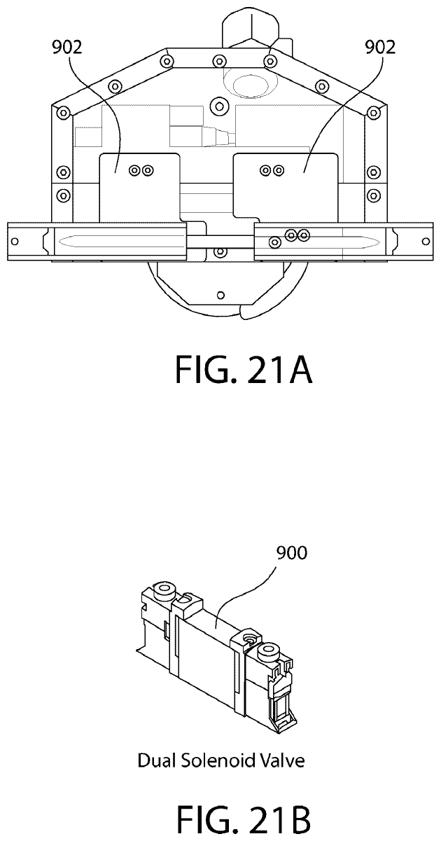

FIGS. 21A and 21B illustrate an embodiment using a dual solenoid gripper valve 902 for the gripping jaws. This gripper may alternatively include emergency close springs, as mentioned above, when operating with a single solenoid valve 900. By using a dual solenoid center close valve, an additional measure of safety is added since the locked valve aids the gripper in staying closed in an emergency stop event, or upon sudden loss of air pressure.

In the foregoing Detailed Description, it can be seen that various features are grouped together in a single embodiment for the purpose of clarity and brevity of the disclosure. This method of disclosure is not to be interpreted as reflecting an intention that the embodiments require more features than are expressly recited herein. Rather, the disclosure is to encompass all variations and modifications to the disclosed embodiments that would be understood to the skilled artisan in light of the disclosure.

What is claimed is:

1. A compact reticle gripper end effector, comprising:
a housing;
two gripper jaws capable of, in combination, gripping the reticle on opposing sides thereof while the reticle is in a compact box, when the two gripper jaws are closed towards each other, the two gripper jaws being located at opposing ends of the housing;
an actuator within the housing and capable of opening and closing the two gripper jaws;
force feedback sensors for sensing gripping of the two gripper jaws; and
a dedicated robotic interface along the housing opposite the two gripper jaws, the dedicated robotic interface capable of interfacing to a 6 axis robotic arm capable of moving the housing.

2. The end effector of claim 1, wherein the two gripper jaws are modular.

3. The end effector of claim 1, wherein the actuator is a single solenoid.

4. The end effector of claim 1, wherein the actuator is a dual solenoid.

5. The end effector of claim 1, further comprising a fiber optic sensor for sensing a spatial relation between the two gripper jaws and the reticle.

6. The end effector of claim 1, further comprising a fiber optic sensor for sensing a spatial relation between the two gripper jaws and a pellicle corresponded to the reticle.

7. The end effector of claim 1, further comprising a harness connector at an uppermost portion of the housing, the harness connector providing actuation to the actuators within the actuator housing.

8. The end effector of claim 7, wherein a harness attached to the harness connector is flexible.

9. The end effector of claim 1, further comprising a camera on the housing for monitoring the two gripper jaws.

10. The end effector of claim 1, wherein the force feedback sensors comprise one or more strain gauges.

11. The end effector of claim 1, further comprising a linear travel sensor in at least one of the gripper jaws.

12. The end effector of claim 11, wherein the linear travel sensor senses that the reticle is at its expected vertical position.

13. The end effector of claim 1, further comprising a spatial inertial sensor to detect path deviation or an accidental collision.

14. The end effector of claim 13, wherein the spatial inertial sensor is on the housing.

15. The end effector of claim 13, wherein the spatial inertial sensor is a miniature 3 axis inertia sensor.
